(19) United States
(12) Patent Application Publication
(10) Pub. No.: US 2012/0282517 A1
(43) Pub. Date: Nov. 8, 2012

(54) ELECTROCHEMICAL CELL AND METHOD FOR PRODUCING SUCH A CELL

(75) Inventors: Claus-Rupert Hohenthanner, Hanau (DE); rer nat. Joerg Kaiser, Eggenstein (DE)

(73) Assignee: LI-TEC BATTERY GMBH, Kamenz (DE)

(21) Appl. No.: 13/500,388

(22) PCT Filed: Sep. 13, 2010
(86) PCT No.: PCT/EP10/05604

§ 371 Date: Jul. 24, 2012

(30) Foreign Application Priority Data
Oct. 5, 2009 (DE) 10 2009 048 237.7

(51) Int. Cl. H01M 2/02; H01M 2/00

(52) U.S. Cl. 429/163; 29/623.1

(57) ABSTRACT

An electrochemical cell includes at least one electrode stack, which is arranged inside a casing of the electrochemical cell, wherein the electrode stack has at least one first electrode layer and one second electrode layer, wherein a separator layer is arranged between the first electrode layer and the second electrode layer, wherein the first electrode layer has a smaller areal extension than the second electrode layer, and wherein an in particular mechanically stabilizing edge layer is arranged adjacent to the first electrode layer.

### CROSS-REFERENCE TO RELATED APPLICATIONS

This application is a National Phase application under 35 U.S.C. §371 of International Application No. PCT/EP2010/005604, filed Sep. 13, 2010 and published as WO 2011/042111 on Apr. 14, 2011, which claims priority to German patent application serial number DE 102009048237.7, filed Oct. 5, 2009, the entirety of each of which is hereby incorporated herein by reference.

### FIELD OF THE INVENTION

The invention relates to an electrochemical cell comprising an electrode stack which particularly has multiple layers of active material. The invention further relates to a method for producing such an electrochemical cell. The invention further relates to a battery having at least one such electrochemical cell.

### BACKGROUND

Lithium ion cells are known in which anodes and cathodes are provided in an alternating arrangement, wherein a separator is provided between each anode and cathode. Particularly in lithium ion cells, the cathodes usually have a smaller areal extension than the anodes. As a result, it is possible for a gap to arise at the edges of the cathodes, so that the anodes may be bent in this area, particularly if external pressure is applied to electrochemical cell. At sites where bending occurs repeatedly, the electrochemical cells may exhibit symptoms of aging.

It is an object of the present invention to provide an improved electrochemical cell.

### SUMMARY

The object underlying the present invention is achieved by an electrochemical cell comprising at least one electrode stack that is arranged inside a casing of the electrochemical cell, wherein the electrode stack has at least one cathode layer and one anode layer, wherein a separator layer is arranged between the first electrode layer and the second electrode layer, and wherein the cathode layer has a smaller areal extension than the anode layer. This electrochemical cell is further characterized in that an edge layer is arranged adjacent to the first electrode layer. The edge layer preferably configured so as to be mechanically stabilizing.

For the purposes of the present invention, an electrode stack is understood to be a device that as a component of a galvanic cell also serves to store chemical energy and emit electrical energy. To this end, the electrode stack comprises a plurality of plate-like elements, at least two electrodes, that is to say an anode and a cathode, and a separator, which absorbs at least some of the electrolyte. Preferably, at least one anode, one separator and one cathode are arranged or stacked one on top of the other, the separator being arranged at least partly between the anode and the cathode. This sequence of anode, separator and cathode may be repeated any number of times within the electrode stack. The plate-like elements are preferably rolled up to form an electrode roll. In the following, the term “electrode stack” is also used for electrode rolls. Before electrical energy is emitted, stored chemical energy is converted into electrical energy. During charging, the electrical energy fed to the electrode stack, that is to say to the galvanic cell, is converted into chemical energy and stored. The electrode stack preferably comprises multiple electrode pairs and separators. Particularly preferably, some electrodes are connected electrically, particularly with each other.

Within the scope of the present invention, the term casing is understood to mean an at least partial delimitation that isolates the electrode stacks from the outside. The casing is preferably impermeable to gases and liquids, so that it is not possible to material to be exchanged with the environment. The electrode stacks are arranged inside the casing. At least one current collector, particularly two current collectors protrude from the casing and serve to connect the electrode stacks. The current collectors protruding to the outside preferably represent the positive terminal and the negative terminal of the electrochemical cell. However, multiple current collectors may protrude from the casing, in particular four current collectors. In this case, if the electrochemical cell comprises two electrode stacks that are connected to one another in series, two electrodes of different electrode stacks are connected to one another.

A current collector is an element that is produced from an electrically conductive material. It is used to conduct current between two points that are geometrically separate from one another. In the present case, a current collector is connected to an electrode stack. In particular, the current collector is connected with all electrodes of the same type in an electrode stack, that is to say either with the cathodes or with the anodes. It is evident that a current collector cannot be connected to the cathodes and the anodes of an electrode stack at the same time, since this would result in a short circuit. But a current collector may be connected to different electrodes from different electrode stacks, for example in a series connection of the two electrode stacks. At least one current collector protrudes out of the casing and may thus serve to connect the electrochemical cell with the outside. The current collector may be constructed integrally with one or more electrodes. The fact that the current collector is particularly not coated with active electrode material may be considered to represent delimitation between the current collector and the electrode.

With the provision of the edge layer on the first electrode layer, it becomes possible to enlarge the cathode layer mechanically. As a result of this enlargement the surface pressure on the electrode layers, particularly the cathode layer, is reduced while the pressure remains the same. In this context, the cathode layer and the edge layer are preferably arranged in the same plane. Then, the separator layer, which lies flush with the first electrode layer and particularly overlaps the cathode layer in an edge area of the first electrode layer, may be supported by the edge layer. In this way, particularly, the anode layer, which is disposed on the side of the separator layer facing away from the first electrode layer, is also supported indirectly by the edge layer. This particularly helps to reduce bending effects that may occur in the overlap area of the separator layer and particularly of the edge areas of the second electrode layer as well. Otherwise, such bending effects may occur particularly when the electrochemical cell is subjected to force, particularly pressure, from the outside. This may particularly happen even while the electrochemical cell is being manufactured.

The edge layer is preferably arranged on at least one side of the first electrode layer. In particular, the edge layer is arranged on a side of the first electrode layer at which a current collector is connected to the cathode layer. In this context, the current collector is preferably not coated with active electrode material. Accordingly, the cross sectional thickness of the current collector may be smaller than the cross sectional thickness of the first electrode layer. Since the edge layer is applied in the area of the current collector, it is thus possible to combine a certain cross sectional thickness of the edge layer with the cross sectional thickness of the current collector to yield in particular a cross sectional thickness that is equivalent to that of the cathode layer in the area of the interface between the current collector and the first electrode layer.

The edge layer is preferably arranged on at least two respectively opposite sides of the first electrode layer. Accordingly, the edge layer may generally be split into multiple edge layer sections that are not adjoined to each other. In this way, this particularly ensures that when the cathode layer is aligned centrally with the second electrode layer the cathode layer may be supported by the edge layer at the axially protruding ends of the second electrode layer.

The edge layer is preferably positioned all around the periphery of the cathode layer. In this way, a continuous border area of the cathode layer may be reinforced. In particular, a peripheral area of the anode layer is supported by the edge layer. The edge layer may form a frame that surrounds and particularly supports the cathode layer.

The electrode layer preferably forms a composite layer together with the edge layer. In this context, the composite layer preferably has the same mechanical properties as would be possessed by a continuous cathode layer. In this way, it is possible to compensate for all of the disadvantages that may arise due to the smaller areal extension of the first electrode layer.

A length of the composite layer is preferably equivalent to a length of the second electrode layer. A width of the composite layer is preferably equivalent to a width of the second electrode layer.

An outline of the composite layer is preferably equivalent to an outline of the second electrode layer. In this context, the term “equivalent to” is to be interpreted broadly as a concept of size. It also particularly includes allowance for tolerances associated with the production process. Additionally, deviations in the single-digit percentage range with regard to both length specifications are entirely acceptable. However, the deviations are preferably relatively small, particularly less than 5% relative to the geometric surface area.

The edge layer preferably has a cross sectional thickness that is essentially equivalent to a cross sectional thickness of the first electrode layer. Also, the edge layer preferably has a hardness that is approximately equivalent to the hardness of the first electrode layer. With similar mechanical properties and similar elastic and/or plastic properties in particular, the edge layer is able to simulate an enlarged cathode layer. In particular, the first layer may be a cathode layer and the second layer may be an anode layer.

The present invention is also solved by a method for producing a species-related electrochemical cell, wherein an edge layer is applied to at least one side of the electrode layer. The edge layer and the first electrode layer may be arranged in the same plane. The edge layer may be arranged on at least one side of the first electrode layer, particularly on a side of the first electrode layer at which a current collector is connected to the first electrode layer. The edge layer may preferably be arranged on at least two respectively opposing sides of the first electrode layer. More preferably, the edge layer may be arranged peripherally around the first electrode layer. Preferably, a composite layer is formed by combining the first electrode layer and the edge layer. Reference is herewith made to the advantages described in the preceding.

Further advantages, features and application possibilities of the present invention will be made evident by the following description in conjunction with the drawing.

### BRIEF SUMMARY OF THE DRAWINGS

FIG. 1 shows a cross section of an electrochemical cell according to the present invention in pancake design.

FIG. 2 is a detail view of an electrochemical cell as shown in FIG. 1 in cross section before an edge layer is applied;

FIG. 3 is a detail view of an electrochemical cell as shown in FIG. 1 in cross section after an edge layer is applied.

FIG. 4a) shows a cathode of the electrochemical cell as shown in FIG. 1 before an edge layer is applied.

FIG. 4b) shows a cathode of the electrochemical cell as shown in FIG. 1 after an edge layer is applied.

FIG. 5a) shows an alternative cathode as shown in FIG. 1 before an edge layer is applied.

FIG. 5b) shows an alternative cathode as shown in FIG. 1 after an edge layer is applied.

FIG. 5c) shows an anode of the electrochemical cell as shown in FIG. 1.

### DETAILED DESCRIPTION

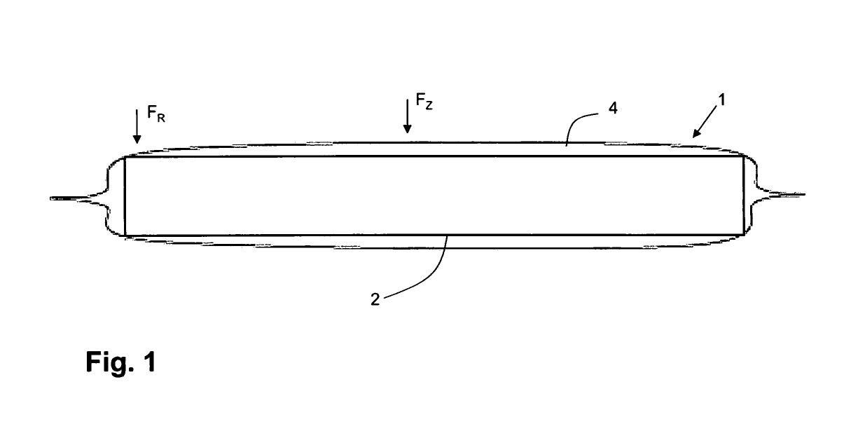

FIG. 1 shows an electrochemical cell 1 according to the present invention. The electrochemical cell 1 comprises an electrode stack 2 that is contained inside a casing 4. Casing 4 is essentially made from two moulded parts that have been produced from packaging foil. The moulded parts have undergone a deep drawing process to create the shape represented. Casing 4 has limited resistance to forces that are exerted on it from the outside, since casing 4 is constructed largely elastically, with the result that forces acting on it from the outside may be transferred to the electrode stack. It may be discerned that forces in edge area F_{R} of electrochemical cell 1 may be greater than forces that occur in central area F_{z}.

FIG. 1 does not show that multiple current collectors 3 are connected to electrode stack 2 in electrically conductive manner and protrude through casing 4.

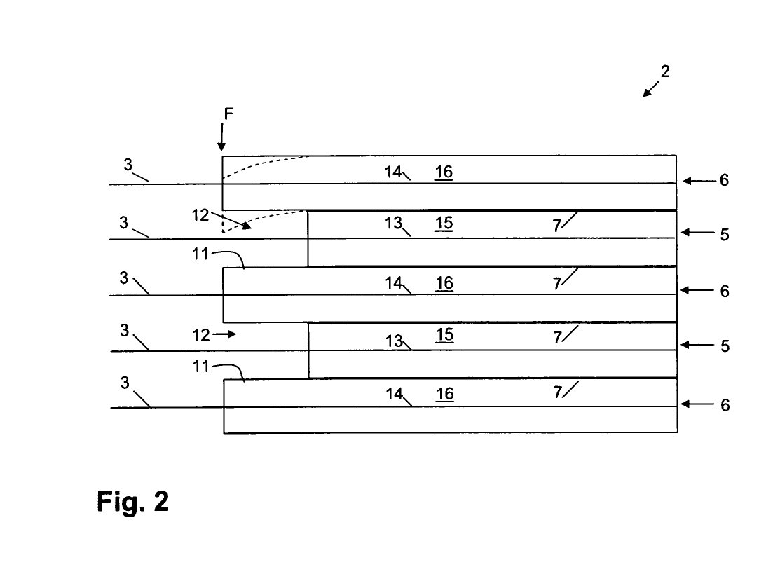

FIG. 2 shows partially an enlarged view of part of the electrode stack 2 of an electrochemical cell 1 as shown in FIG. 1. Electrode stack 2 comprises a plurality of first electrode layers 5 and a plurality of second electrode layers 6. Electrode layers 5, 6 are of flat construction and are arranged parallel to a plane E. First electrode layers 5 and second electrode layers 6 are arranged alternatingly with each other. A separator layer 7 is arranged between each first electrode layer 5, which in the present case is a cathode layer, and each second electrode layer 6, which in the present case is an anode layer.

Current collectors 3 are shown disposed outside of electrode layers 5, 6. Extensions of current collectors 3 inside electrode layers 5, 6 form electrodes 13, 14. Thus, a cathode 13 is provided inside cathode layer 5; and anode 14 is provided inside anode layer 6. Current collectors 3 may be constructed as a single part with the respective electrodes 13, 14; however, current collectors 3 may also be constructed separately from electrodes 13, 14 and connected in electrically conductive manner thereto.

Cathode layer 5 has a smaller areal extension than anode layer 6. It is thus evident that anode layer 6 extends beyond cathode layer 5 in an edge area 11. As a result, gaps 12 are formed between each of two anode layers 6, which gaps are delimited by a side 9 of cathode layer 5. Because of the existence of gap 12, if external force is applied to anode layers 6 perpendicularly to the respective planes E of the layers, it is not opposed by any resisting force, with the result that anode layers 6 may be bent into gaps 12 in edge area 11, as is indicated by the dashed lines. This may result in symptoms of aging in the electrode stacks.

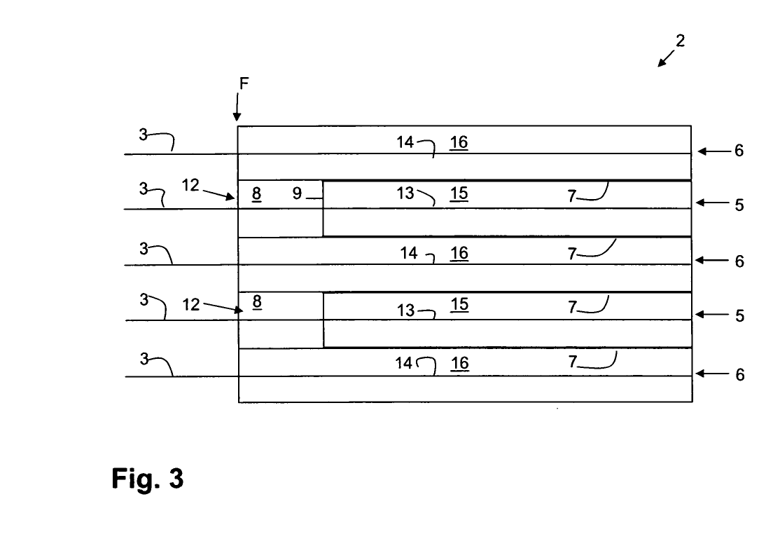

FIG. 3 shows the portion of electrode stack 2 according to FIG. 2 after the application of an edge layer 8. This shows that gap 12 has been completely filled in with the polyurethane edge layer 8. In this context, edge layer 8 has been applied to one side 9 of cathode layer 5 and is arranged in the same plane E as the cathode layer. In this respect, cathode layer 5 and edge layer 8 form a composite layer 10, which is arranged between two respective anode layers 6. Since gap 12 is now filled in by edge layer 8, edge layer 8 functions as an element that provides resisting force and is able to prevent anode layer 6 from bending in edge area 11. Edge layer 8 also has a hardness that is equivalent to the hardness of cathode layer 5.

Edge layer 8 serves as a mechanical stabilizer, particularly for anode layer 6.

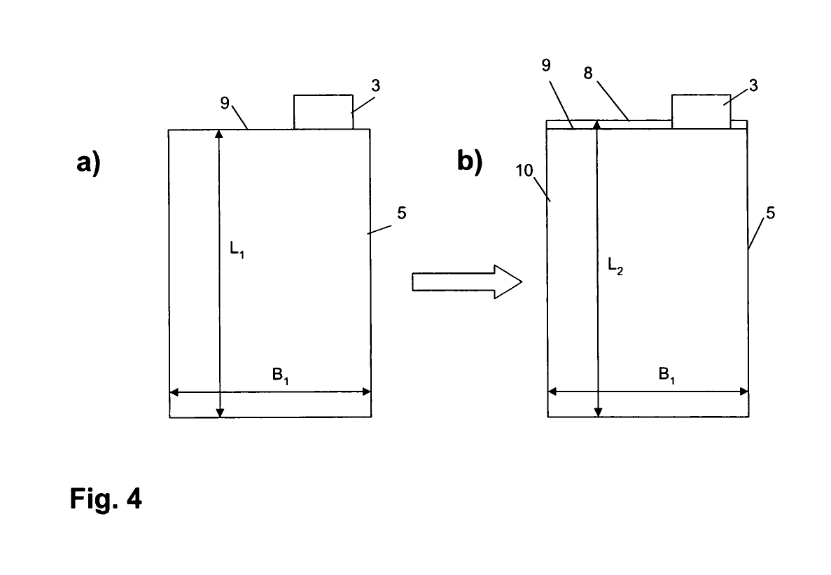

FIG. 4a) shows a cathode layer 5 before an edge layer is applied. Cathode layer 5 has a length L₁ and a width B₁. Current collector 3 is connected to the cathode at a side 9.

In FIG. 4b), it may be seen that edge layer 8 has been applied to side 9 of cathode layer 5. An edge layer 8 is not applied to the other sides of cathode layer 5. It may be seen that the composite layer 10 formed by cathode layer 5 and edge layer 8 now has a length L₂, while the width B₁ is unchanged from the corresponding width of cathode layer 5.

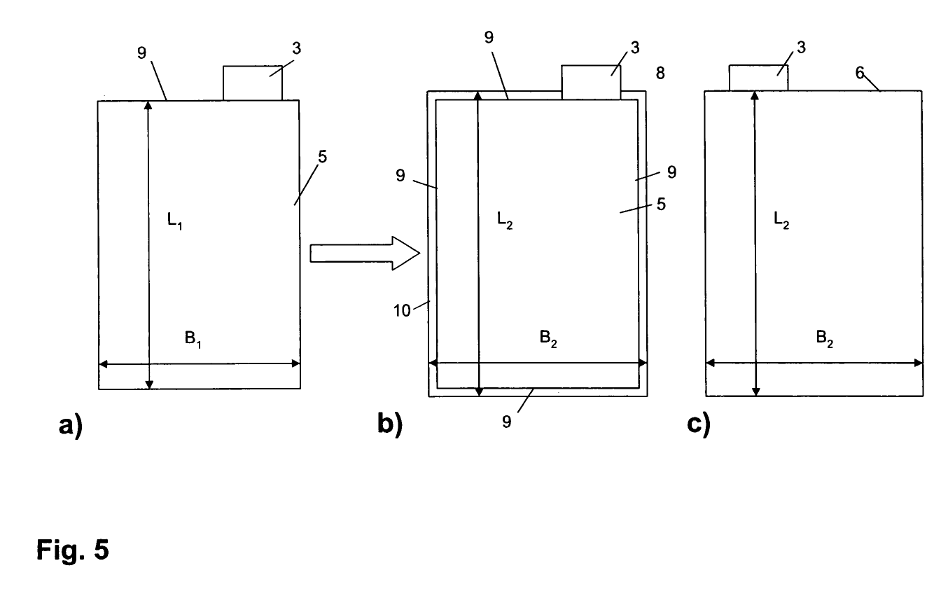

FIG. 5b) shows a refinement of the present invention as shown in FIG. 4. As shown in FIG. 5b), an edge layer 8 is applied to cathode layer 5 all around the periphery of cathode layer 5, thereby forming a composite layer 10. Length L₂ and width B₂ of composite layer 10 are thus both larger than length L₁ and width B₁ of cathode layer 5.

FIG. 5c) shows an example of an anode layer 6 of the electrochemical cell according to the present invention. Here, length L₂ is equivalent to length L₂ of composite layer 10. In this context, width B₂ of anode layer 6 is equivalent to width B₂ of composite layer 10.

### LEGEND

1 Electrochemical cell
2 Electrode stack
3 Current collector
4 Casing
5 Cathode layer
6 Anode layer
7 Separator layer
8 Edge layer
9 Side
10 Composite layer
11 Edge area
12 Gap
13 Cathode
14 Anode
15 Active cathode material
16 Active anode material
E Plane
B Width
L Length
F Force

1-18. (canceled)

19. An electrochemical cell, comprising:
at least one electrode stack, which is arranged inside a casing of the electrochemical cell, wherein the electrode stack has at least one first electrode layer and one second electrode layer, wherein a separator layer is arranged between the first electrode layer and the second electrode layer, and wherein the first electrode layer has a smaller areal extension than the second electrode layer, wherein an edge layer is arranged adjacent to the first electrode layer, wherein the first electrode layer together with the edge layer forms a composite layer.

20. The electrochemical cell as recited in claim 19, wherein the first electrode layer and the edge layer are arranged in a common plane.

21. The electrochemical cell as recited in claim 19, wherein the edge layer is arranged at least on one side of the first electrode layer.

22. The electrochemical cell as recited in claim 19, wherein the edge layer is arranged at least on two respectively opposite sides of the first electrode layer.

23. The electrochemical cell as recited in claim 19, wherein the edge layer is arranged all around the periphery of the first electrode layer.

24. The electrochemical cell as recited in claim 19, wherein a length of the composite layer is equivalent to a length of the second electrode layer.

25. The electrochemical cell as recited in claim 19, wherein a width of the composite layer is equivalent to a width of the second electrode layer.

26. The electrochemical cell as recited in claim 19, wherein the edge layer has a cross-sectional thickness that is essentially equivalent to a cross-sectional thickness of the first electrode layer.

27. The electrochemical cell as recited in claim 19, wherein the edge layer has a hardness that is approximately equivalent to the hardness of the first electrode layer.

28. The electrochemical cell as recited in claim 19, wherein the first electrode layer is a cathode layer and the second electrode layer is an anode layer.

29. A battery having at least one electrochemical cell as recited in claim 19.

30. A method, comprising:
producing an electrochemical cell, wherein the electrochemical cell comprises at least one electrode stack that is arranged inside a casing of the electrochemical cell, wherein the electrode stack comprises at least one first electrode layer and one second electrode layer, wherein a separator layer is arranged between the first electrode layer and the second electrode layer, and wherein the first electrode layer has a smaller areal extension than the second electrode layer, wherein an edge layer is arranged at least on one side of the first electrode layer wherein a composite layer is formed by a combination of the first electrode layer together with the edge layer.

31. The method as recited in claim 30, wherein the edge layer and the first electrode layer are arranged in a common plane.

32. The method as recited in claim 30, wherein the edge layer is arranged at least on one side of the first electrode layer.

33. The method as recited in claim 30, wherein the edge layer is arranged at least on two respectively opposite sides of the first electrode layer.

34. The method as recited in claim 30, wherein the edge layer is arranged all around the periphery of the first electrode layer.
